(19) United States
(12) Patent Application Publication
(10) Pub. No.: US 2023/0142154 A1
(43) Pub. Date: May 11, 2023

(54) A MICROFLUIDIC DEVICE FOR PURIFYING NANO-STRUCTURES

(71) Applicant: CORLAM NANO VE BIYOTEKNOLOJI BIYOMED AR.GEL.SAN VE TIC. A. S., Golbasi, Ankara (TR)

(72) Inventor: Mehmet Dogan ASIK, Golbasi, Ankara (TR)

(21) Appl. No.: 17/907,597

(22) PCT Filed: Feb. 8, 2021
(86) PCT No.: PCT/TR2021/050111

§ 371 Date: Sep. 28, 2022

(30) Foreign Application Priority Data
Sep. 10, 2020 (TR) 2020/14391

(51) Int. Cl. B01L 3/00; B01L 7/00

(52) U.S. Cl. CPC B01L 3/502761; B01L 7/00; B01L 2200/0652; B01L 2300/18; B01L 2300/0864; B01L 2400/086

(57) ABSTRACT

Disclosed is a nanostructure purification device which is connected to microfluidic systems or microfluidic flow, which allows the nanostructures in the microfluidic systems or flow to accumulate on a surface during flow and thus used for separation, purification, washing or enrichment of nanostructures.

### TECHNICAL FIELD

The present invention relates to a microfluidic nanostructure purification device used to separate, purify, wash, or enrich nanostructures by accumulating nanostructures on a surface of a microfluidics channel while the flow passes through it.

### PRIOR ART

Structures with a size of nanometers (nm), especially between 1-300 nanometers (nm), are called nanostructures. Nanostructures are fundamental parts of nanotechnology. Nanostructures exhibit properties that are considered far different and superior to mass-built materials. Nanostructure is a class that contains many structures such as nanoparticles, nanocubes, nanofibers, and nanocrystals. Nanostructures are used in many industries, including electronics, biomedical, automotive and chemical sectors, due to their superior properties.

Nanostructures are distinguished by factors such as their electronic structure, size range, quantum size effects, characters of surface atoms, and high surface volume ratios. Thanks to the production of nanostructures, many technological products such as anti-wear surfaces, surfactants, pharmaceutical products, superconductors have been developed. Thanks to the nanomaterials being nano-sized, nano-sized devices such as drug carriers, nano-sensors, nano-machines can be made.

In the present day, nanostructures with the desired properties can be prepared from metal, metal alloy, ceramic, polymer based or a mixture of them with doped, spherical, hollow, rod-like structures. For producing metallic and oxide nanostructures chemical vapor condensation, hydrogen reduction, inert gas condensation, production from micro-heterogeneous systems, mechanical etching, different methods such as ultrasonic spray pyrolysis technique are used.

The main technique known and used today to separate or purify nanostructures after they are produced is the centrifugal separation technique. In addition to the nanostructures produced by the chemical method, there are residual chemicals in solution. From the existing known nanostructure purification methods, centrifugal separation is used to separate these residual chemicals. In said method, centrifugal devices are usually used, and nanostructures are separated from a chemical liquid phase with high g force.

Although it is possible to produce nanostructure with flow systems, it is difficult and a major technical problem to add centrifugal process into the flow system. Nanostructures harvested from the flow system are taken into the centrifugal process. After the centrifugal process is completed, the washing process is carried out in two or three stages optionally. The nanostructures are washed by the washing process. But the said washing process can be inconvenient and costly.

One of the most important technical problems related to nanostructure production is the lack of a washing, purification device that can be easily integrated into microfluidic systems that produces nanostructures. Another technical problem is that there is no single device that allows the separation, purification, washing or enrichment of nanostructures. Another technical problem is that the methods used to obtain nanostructure are long and costly.

The suggested device of the present invention allows the nanostructures in microfluidic to be produced, washed, separated, or purified by collecting them on a surface with heat, and the device suggested in the application can perform the processes of purification, washing, separation and enrichment nanostructures.

In the current technique, there is no microfluidic device that can be integrated into microfluidic systems, through which the microfluidic is passed, which enables the separation of nanostructures in microfluidic by heat change (hot or cold), which can also be used to produce nanostructures, and can be used for washing, purifying, separating, or enriching nanostructures.

### OBJECTIVES OF THE INVENTION

An object of this invention is to provide a nanostructure purification device that allows the nanostructures in a fluid to be separated, purified, washed or enriched without the need for centrifugation.

Another object of this invention is to provide a nanostructure purification device that allows nanostructures to accumulate (condense) with heat exchange at a point.

Still another object of this invention is to perform a nanostructure purification device that allows the washing of nanostructures created in microfluidics, to be performed in a single device.

### BRIEF DESCRIPTION OF THE INVENTION

An object of this invention is to provide a device, as defined in the first claim and the other claims dependent on this claim, which comprises channel, fluid inlet, fluid outlet, obstacle/hurdle, heat changer and control unit.

The channel forming fundamental structure of the nanostructure purification device is preferably in the form of a rectangular prism and has a completely or partially hollow structure inside. By the space in the channel, the fluids can pass there through the microfluidics device. It flows through the cavity in the microfluidic channel. In the channel, there may be obstacles/hurdles that can be hit by the fluid that can preferably change the properties of the flow, such as velocity, structure, direction, and dynamics. There is at least one inlet and at least one outlet for the fluid connected to the channel to enter and exit the channel. The fluid enters the channel through the said inlet and exits through the said outlet. As the fluid passes through the channel, it moves forward, hitting obstacles/hurdles or surfaces located inside the channel. Heat changers in the structure of the channel create regional heat differences, leading to the accumulation of nanostructures in the fluid at certain points. The flow rate, flow dynamics, flow form and regional temperature differences are controlled at the same time and nanostructures are purified by separating the nanostructures from the liquid they are in and taking them into a different liquid by different algorithms. The nanostructure purification device is used to separate, purify, wash, or enrich nanostructures contained in microfluidic.

Nanostructures given by microfluidic enter through the fluid inlet connected to the channel, progress through the flow of the fluid in the channel, on the inner surface of the channel. The fluit inlet is placed in contact with the channel and enters into the channel. Due to the width variations in the channel, the fluid flowing through the fluid inlet moves through the narrower passages and then extends to a wider sections. The velocity of the fluid is decreased as the fluid passes through the narrower passages to wider sections, and the velocity is increased while the fluid moves through wider passages and directed to narrower sections. The properties of the flow inside the channel can be altered by making use of this feature.

In the nanostructure purification device, there are collision surfaces with different geometric shapes inside the channel. Collision surfaces can be in different geometric forms, shapes, patterns, structures within the channel or can be placed in the channel. The collision surfaces are located in the channel, between the fluid inlet and outlet. Nanostructures in the fluid enters through the fluid inlet are directed to the fluid outlet after hitting the collision surface. Because the collision surfaces are positioned between the fluid Inlet and the fluid outlet in such a way that the microfluidic will hit, the microfluidic hits the collision surface or surfaces as it proceeds through the channel.

In an embodiment of the present invention, there are heat changers inside the channel, preferably on the collision surface or on the inner surface of the channel. Heat changers are located on the inner surface of the channel and/or on collision surfaces. Heat changers can perform heating or cooling. When the heat changers operate, they change the heat on the surface on which they are located, in other words on the inner surface of the channel and/or the collision surface and performs heating or cooling on the said surface.

Heat changers can be in different geometric forms and can cover all or part of the surface where they are located. Heat changers are preferably powered by electricity and controlled by a control unit. Heat changers can work continuously, as well as in an intermittent/pulsed way. In the preferred embodiment of the invention, heat changers work in pulsed manner, at the same time, the fluid supply can be intermittent/pulsed or continuous, they work for the preferred time and stop working for the preferred time.

Nanostructures in microfluidics, which enter the cavity in the channel from the fluid inlet, spread into the channel and move through the channel. When nanostructures enter the channel, heat changers are activated. Along with the operation of heat changers, there is a change in temperature (heating or cooling) on the collision surfaces where heat changers are located and/or on the inner surface of the channel. Nanostructures that hit the said heat-altered surfaces accumulate in this area by holding them around heat changers. Nanostructures in the fluid are accumulated around the heat changer as heat changers are activated by given pulses. It is ensured that the nanostructures dispersed in the fluid remain stable and accumulate at the sections where heat changers are placed.

While the nanostructures in the microfluidic accumulate around the heat changers, the other fluid can be removed from the space in the channel towards the fluid outlet. In this way, the nanostructures contained in the microfluidic are collected on a surface the temperature of which is changed, and they are separated from the microfluidic. After the separation and accumulation of nanostructures on a surface, the nanostructures can be passed through different processes to produce, separate, wash or enrich the nanostructures.

### DETAILED DESCRIPTION OF THE INVENTION

An object of this invention is to provide a nanostructure purification device which is shown in the accompanying figures, wherein;

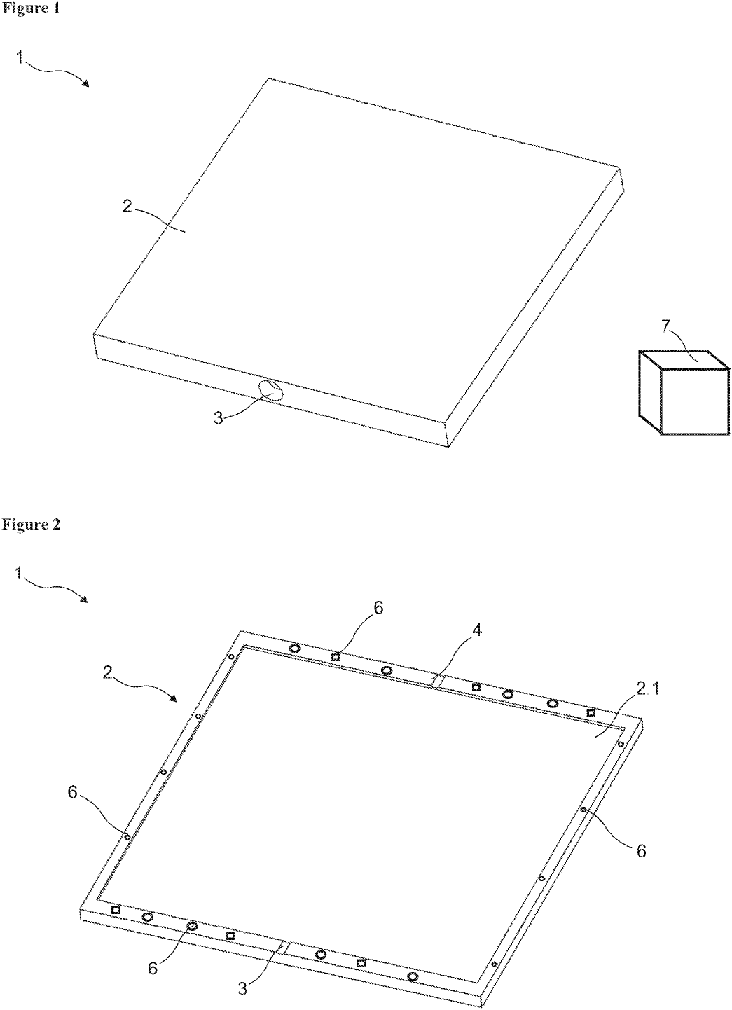

FIG. 1 is a perspective view of the nanostructure purification device.

FIG. 2 is a perspective view of an embodiment of the nanostructure purification device in cross-section with the channel-like heat changers.

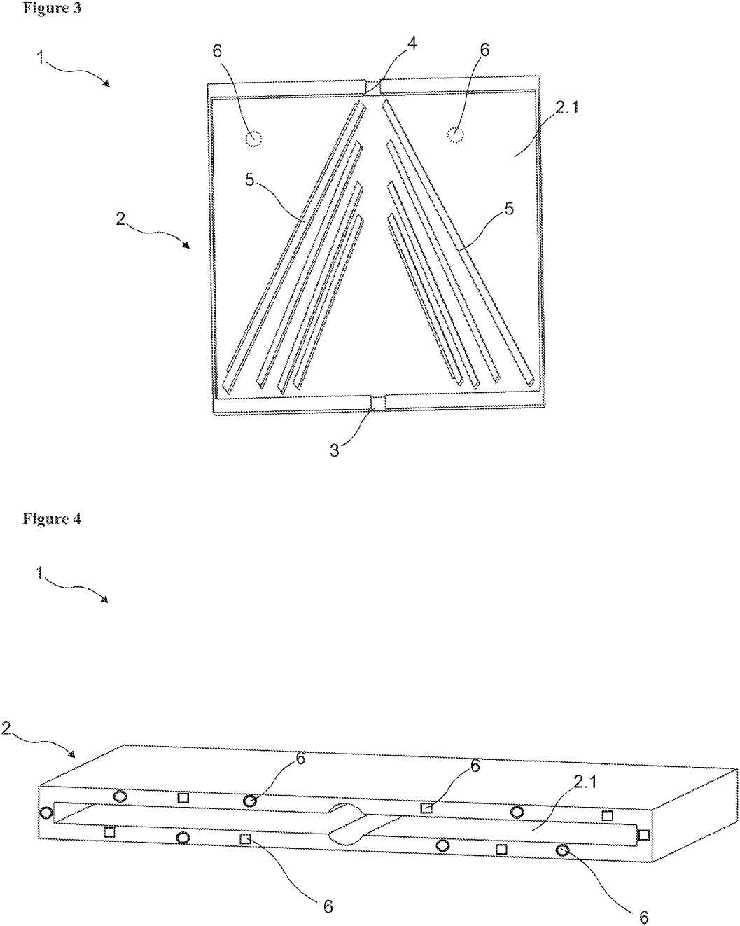

FIG. 3 is a sectional view of a different embodiment of the nanostructure purification device.

FIG. 4 is the perspective view of the heat changers installed in the channel structure in vertical section of the nanostructure purification device.

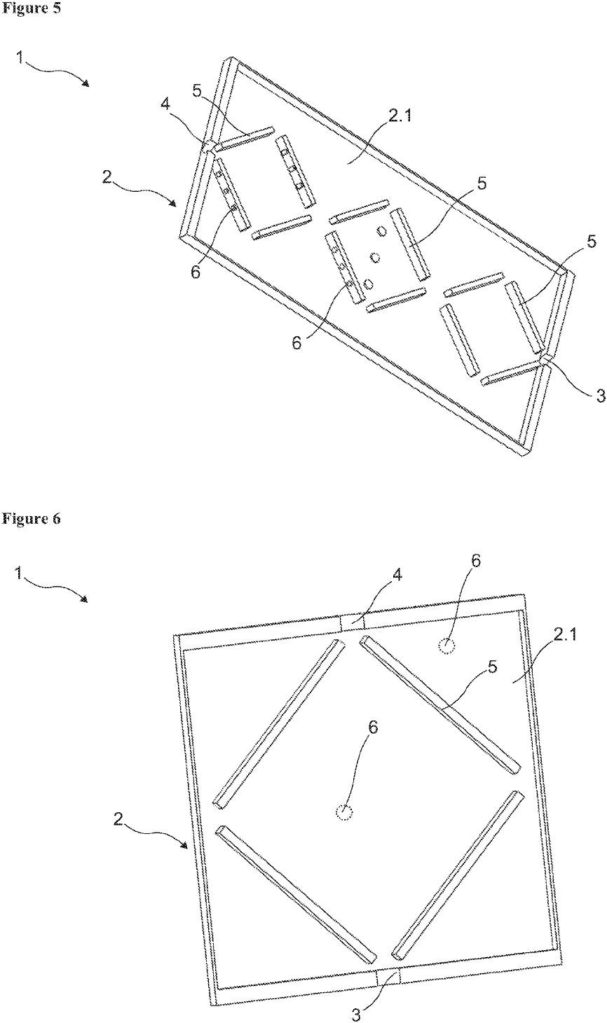

FIG. 5 is a sectional view of a different embodiment of the nanostructure purification device.

FIG. 6 is a sectional view of a different embodiment of the nanostructure purification device.

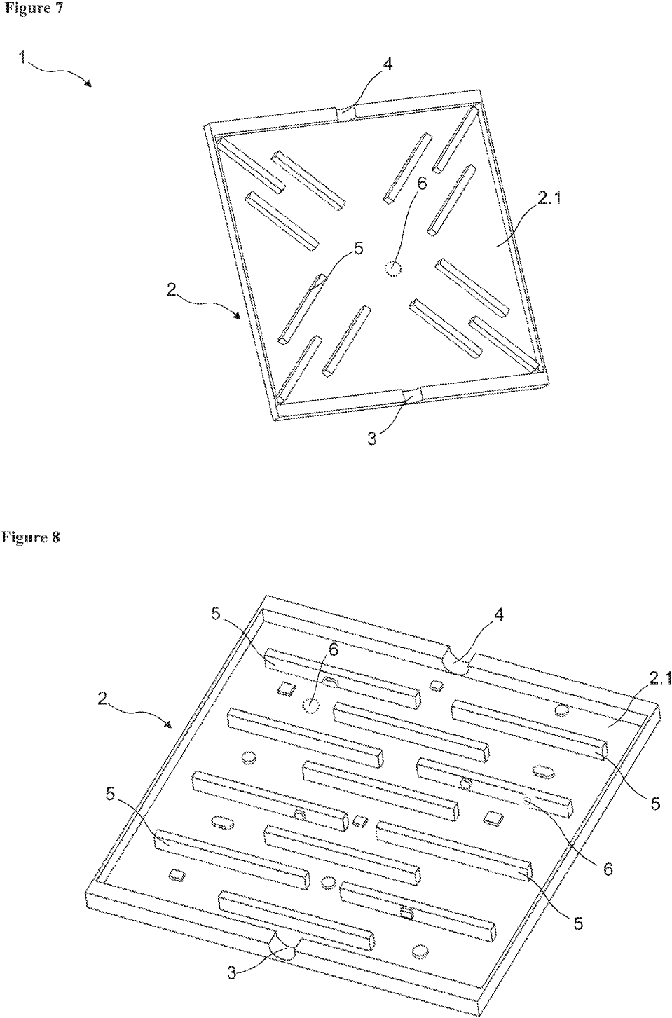

FIG. 7 is a sectional view of a different embodiment of the nanostructure purification device.

FIG. 8 is a sectional view of a different embodiment of the nanostructure purification device.

The parts in the figures are numbered individually and the equivalents of these numbers are given below.
1. Nanostructure purification device
2. Channel
   2.1. Inner surface
3. Fluid inlet
4. Fluid outlet
5. Obstacle/Hurdle
6. Heat changer
7. Control unit

A microfluidics nanostructure purification device (1) used to separate, purify, wash or enrich nanostructures by accumulating nanostructures on a surface of a microfluidics channel while the flow passing through it, characterized by;
at least one microchannel (2), which connects to the microfluidic system or a flow source, inner surface (2.1) of which has a completely or partially void structure to form a cavity, nanostructures pass through the said cavity together with the fluid, at least one of the widths, length or height of the channel is maximum 1000 micrometer,
at least one fluid inlet (3) connected to the channel (2) and allowing the fluid to enter the microchannel (2),
at least one fluid outlet (4) connected to the channel (2) and enables the fluid to exit from the microchannel (2),
at least one obstacle/hurdle (5) located between the fluid inlet (3) and the fluid outlet (4) in the channel (2), which changes the flow properties of the fluid in the channel (2) by forming open chambers or notches in the channel (2),
at least one heat changer (6), which is formed by a heat exchanger and a heating/cooling source, is placed in the channel (2) structure, inside the channel (2) or in/on the obstacle/hurdle (5) structure in the channel, creating a regional heat change by heating or cooling it in the channel (2) and allowing the accumulation of nanostructures at the point where it is located.

Nanostructure purification device (1) of the application is used for separation, purification, washing or enrichment of nanostructures by integrating them into microfluidic systems and ensuring that nanostructures accumulate on a surface. The nanostructure purification device (1) is preferably integrated into a microfluidic system; in other words, the microfluidic is passed through the nanostructure purification device (1). There are nanostructures in the microfluidic, and the said microfluidic nanostructure passes through the purification device (1). Nanostructures in microfluidics accumulate in the nanostructure purification device (1) exchange on the channel (2) or obstacle/hurdle (5) due to heat. Microstructures, like nanostructures, can accumulate and separate within this system. Nanostructures accumulated according to the purpose of use of the nanostructure purification device (1) can be used for different purposes by taking or washing from the said surface or concentrating more.

An embodiment of the invention includes a nanostructure purification device (1), channel (2), fluid inlet (3), fluid outlet (4), obstacle/hurdle (5), heat changer (6) and control unit (7). Nanostructure purification device (1) is used by integrating into microfluidic systems. The nanostructure purification device (1) provides accumulation of nanostructures created in microfluidics on a specific surface. Since the nanostructure purification device (1) enables the accumulation of nanostructures on a certain surface, the nanostructure purification device (1) can be used in the processes of separation, purification, washing, separation, or enrichment of nanostructures. The nanostructure purification device (1) can be used by connecting to the back of a microfluidic system that produces the nanostructure. Nanostructure purification device (1) can be used in combination with microfluidics containing any nanostructure or liquid containing nanostructures. The liquid or microfluidic nanostructure containing the said nanostructure is transferred into the channel (1) within the purification device (2).

The channel (2) involved in an embodiment of the invention is connected to the microfluidic system. The channel (2) is completely or partially hollow. The channel (2) is preferably in the form of a rectangular prism. The liquid containing the nanostructure or microfluidic flows through the space in the channel (2). Nanostructures pass through the cavity in the channel (2) along with microfluidics. The channel (2) may contain microchannels, preferably micro-sized, in other words larger than the nanostructure. The microchannels in question can be in the structure of the channel (2). In an embodiment of the present invention, there is a space in the channel (2), preferably having a maximum height of 100,000 micrometers and 1 micrometer. The channel (2) contains a cavity in micro dimensions. The collision surfaces (5) are preferably placed in the space inside the channel (2). Heat changers (6) are in the structure of the channel (2). The microfluidic flows through the cavity in the channel (2). Fluid inlet (3) and fluid outlet (4) are located on channel (2).

In an alternative embodiment of the invention, the lower surface of the channel (2) can be made of materials such as glass, polymetalmetacrylate (PMMA). At the same time, structures with micro-sized channels can be found on the inner surface of this channel (2). Micro-sized channels located on the inner surface (2.1) of the channel (2) can be observed from the lower surface of the channel (2). Heat changers (6) can be placed in the said micro-sized channels located in the structure of the channel (2).

There is at least one fluid inlet (3) and at least one fluid outlet (4) for the fluid connected to the channel (2) to enter and exit the channel (2). The microfluidic enters the channel (2) from the said fluid inlet (3) and exits from the said fluid outlet (4). As the microfluidic passes through the channel (2), it proceeds by hitting the obstacles/hurdles (5) or the surfaces of the obstacles/hurdles (5) located within the channel (2). Heat changers (6) in the structure of the channel (2) create regional heat differences, leading to the accumulation of nanostructures in the fluid at certain points. Differences of the flow rate, flow structure, flow form and regional temperature of the microfluidic entering the channel (2) from the fluid inlet (3) are controlled at the same time and nanostructures are purified by separating the nanostructures from the liquid they are in and taking them into a different liquid by different algorithms. The nanostructure purification device is used to separate, purify, wash or enrich nanostructures contained in microfluidic.

In one embodiment of the invention, the fluid inlet (3) is located on the channel (2). The fluid inlet (3) allows the microfluidic to enter the channel (2). Nanostructures given by microfluidic enter through the fluid inlet (3) connected to the channel (2), progress through the flow of the fluid in the channel (2), on the inner surface of the channel. The fluid inlet (3) is used in the entrance of the microfluidic containing the nanostructure, the microfluidic in solution or the pure water to be used to wash the nanostructures into the channel (2). The fluid inlet (3) is located in part of the channel (2) and opens into the channel (2). Because of the width of the fluid inlet (3) and channel (2), the fluid entering from the fluid inlet (3) opens from a narrow area to a wide area. As the fluid enters the channel (2), its velocity decreases as it passes from a narrow area to a wide area, and its velocity increases when it passes from a wide area to a narrow area. By using this feature, the properties of the flow inside the channel (2) can be changed.

The fluid inlet (3) in an embodiment of the invention is located at the preferably midpoint of one edge of the channel (2). The fluid inlet (3) can be in different geometric forms. The fluid inlet (3) opens into the micro-sized cavity in the channel (2). It is possible for the microfluidic to pass through the fluid inlet (3) from a narrow area to the wide space in the channel (2). The fluid inlet (3) can be adapted to be wide, narrow or thin. In cases where the fluid inlet (3) is narrow, its velocity decreases when the microfluidic passing through the fluid inlet (3) reaches the inner surface of the channel (2).

In an embodiment of the present invention, the fluid outlet (4) is located on the channel (2), preferably facing the fluid inlet (3). The fluid outlet (4) provides an exit of the microfluidic through the channel (2). The fluid outlet (4) is used in the exit of the microfluidic containing the nanostructure, the microfluidic in the solution or the pure water to be used to wash the nanostructures outside the channel (2) or to the external environment. While the microfluidic exits through the channel (2), it exits from the fluid outlet (4). The fluid outlet (4) can be in different geometric forms. The fluid outlet (4) opens to the outside environment through the micro-sized space inside the channel (2). The microfluidic, which is passed to the fluid outlet (4), can pass through the wide space in the channel (2) to a narrow area. The fluid outlet (4) can be adapted to be wide, narrow or thin. The fluid outlet (4) is positioned to be reciprocal with the fluid inlet (3). In this embodiment of the present invention, the fluid outlet (4) is positioned to the edge of the channel (2) which is parallel to the fluid inlet (3). In alternative embodiments of the invention, the fluid outlet (4) can be located in different places of the channel.

In an embodiment of the present invention, the obstacle/hurdle (5) is placed in the channel (2) between the fluid inlet (3) and the fluid outlet (4). As the microfluidic passes through the channel (2), it proceeds by hitting the obstacles/hurdles (5) or the surfaces of the obstacles/hurdles (5) located within the channel (2). Heat changers (6) in the structure of the channel (2) create regional heat differences, leading to the accumulation of nanostructures in the fluid at certain points. Differences of the flow rate, flow structure, flow form and regional temperature of the microfluidic entering the channel (2) from the fluid inlet (3) are controlled at the same time and nanostructures are purified by separating the nanostructures from the liquid they are in and taking them into a different liquid by different algorithms. The nanostructure purification device is used to separate, purify, wash or enrich nanostructures contained in microfluidic. The obstacle/hurdle (5) creates open chambers, recesses, or notches in the channel (2), creating surfaces that the microfluidic within the channel (2) hits during the flow. The obstacle/hurdle (5) can change properties such as the velocity, structure, direction, and shape of the flow, preferably in the case where the fluid hits inside the channel (2). One or more obstacles/hurdles (5) can be placed in the cavity in the channel (2). There can be obstacles/hurdles (5) of different geometries and shapes in the cavity within the channel (2) with a height between 1 and 100 micrometers. The obstacle/hurdle (5) is located in the channel (2) and provides the surfaces where the flow will hit while the flow passes through the channel (2). As the microfluidic flows from the inner surface (2.1) in the channel (2), it contacts the collision surfaces (5). In the nanostructure purification device (1), the obstacles/hurdles (5) form the surfaces that the microfluidic will hit and touch during the flow, and the nanostructures are accumulated around the heat changer (6) and the obstacles/hurdles (5) with the heat changers (6) on the obstacle/hurdle (5). Heat changers (6) allow nanostructures to accumulate, collect, hold on the obstacle/hurdle (5) and/or the channel (2) where they emit heat. The obstacle/hurdle (5) can be of different geometric forms and can be positioned differently in the cavity inside the channel (2). The obstacles/hurdles (5) are placed in the channel (2) in a manner that triggers the accumulation of nanostructures in the microfluidic around the heat changers (6). The obstacles/hurdles (5) play a role in directing the microfluidic on the channel (2). The obstacles/hurdles (5) can be randomly placed in the channel (2), as well as placed in such a way as to slow or accelerate the micro flow or direct it in the preferred direction. By changing the location, frequency, angle, and position of the obstacle/hurdle (5) in the channel (2) according to the fluid inlet (3) and the fluid outlet (4), the flow direction of the microfluid, the flow density and the number of impacts can be changed and thus, the surface on which nanostructures will be collected and the density of nanostructures can be controlled. In an embodiment of the present invention, the obstacles/hurdles (5) allow the microfluidic to slow down in the channel (2) and to accumulate more easily around the heat changer (6) by switching to a low flow rate.

In another embodiment of the present invention, only the heat changers (6) can be utilized without the presence of obstacles/hurdles (5) in the nanostructure purification device (1).

In the nanostructure purification device (1), there are obstacles/hurdles (5) in different geometric forms inside the channel (2). The obstacles/hurdles (5) can be or placed in the channel (2) in different geometric forms, shapes, patterns, structures. The obstacles/hurdles (5) are located in the channel (2), between the fluid inlet (3) and the fluid outlet (4). The obstacle/hurdle (5) allows the flow properties (velocity, direction, shape, etc.) to be changed or divided by directly hitting by the fluid passing through the channel (3). Nanostructures located in microfluidics and entering through the fluid inlet (3) are directed to the fluid outlet (4) after hitting the obstacles/hurdles (5). Since the obstacles/hurdles (5) are positioned between the fluid inlet (3) and the fluid outlet (4) in such a way that the microfluidic hits, it hits the obstacles/hurdles (5) or the surfaces of the obstacles/hurdles (5) while moving through the channel (2).

In another embodiment of the present invention, the obstacles/hurdles (5) are placed in the channel (2) in a vertical position to the fluid inlet (3) and the fluid outlet (4) (FIG. 2). When obstacles/hurdles (5) are placed vertically at the fluid inlet (3) and fluid outlet (4), the fluid directly hits the collision surfaces (5) and slows down while the microfluidic passes from the fluid inlet (3). At the same time, the flow is divided and directed. The microfluidic entering from the fluid inlet (3) on the channel (2) is divided into two by the first obstacle/hurdle (5), then the microfluidic moving in each direction is divided into two and proceeds again. Each obstacle/hurdle (5) allows the flow to be re-divided and directed in the preferred direction.

In another embodiment of the present invention, the obstacles/hurdles (5) are placed in the channel (2) at an angle that starts narrowly from the fluid inlet (3) and widens towards the fluid outlet (4) (FIG. 4). The obstacles/hurdles (5) placed at an angle enable the fluid passing through the fluid inlet (3) to directly hit the obstacles/hurdles (5) and slow down.

In another embodiment of the present invention, the obstacles/hurdles (5) are placed in the channel (2) with an angle that starts narrowly from the fluid inlet (3) and widens towards the fluid outlet (4) and different obstacles/hurdles (5) are positioned in such a way that there will be more than one consecutive length between them (FIG. 3). The obstacles/hurdles (5) placed at an angle enable the fluid passing through the fluid inlet (3) to directly hit the obstacles (5) and slow down.

In another embodiment of the invention, the obstacles/hurdles (5) are placed in the channel (2) perpendicular to each other in a rectangular geometric form. The said obstacles/hurdles (5) are placed so that their corner parts face the fluid inlet (3) and the fluid outlet (4) (FIG. 6). The microfluidic flowing in the channel (2) by hitting the collision surfaces (5) placed at an angle, hits the other narrowing barriers (5) placed in opposite directions.

In another embodiment of the invention, the obstacles/hurdles (5) are placed in the channel (2) in a consecutive set of corners by forming a rectangular geometric form perpendicular to each other. The said obstacles/hurdles (5) are placed so that their corner parts of the rectangular form face the fluid inlet (3) and the fluid outlet (4) (FIG. 6). The microfluidic moving forward in the channel (2) by hitting the collision surfaces (5) placed in an angle, hits the other narrowing obstacles/hurdles (5) and consecutively located obstacles/hurdles (5) placed in the opposite direction.

In another embodiment of the invention, the obstacles/hurdles (5) are positioned consecutively and intermittently in the channel (2) such that they extend from the corner parts of the space to the center of the channel (2) (FIG. 7). The microfluidic passing through the fluid inlet (3) expands and progresses in the channel (2) and hits the narrowing obstacles/hurdles (5).

In an embodiment of the invention, the heat changer (6) is located in the channel (2) structure and/or on the obstacles/hurdles (5). The heat changer (6) ensures that the structure of the channel (2) or the obstacles/hurdles (5) is heated or cooled, allowing the channel (2) structure or the nanostructures in the microfluidic to accumulate on the obstacle/hurdle (5) due to heat change. The heat changer (6) can be positioned on the structure of the channel (2) or on the surface of obstacles/hurdles (5). The heat changer (6) can be in different geometric forms and can be placed in different positions. Heat changers (6) in the structure of the channel (2) create regional heat differences, leading to the accumulation of nanostructures in the fluid at certain points. Differences of the flow rate, flow structure, flow form and regional temperature of the microfluidic entering the channel (2) from the fluid inlet (3) are controlled at the same time and nanostructures are purified by separating the nanostructures from the liquid they are in and taking them into a different liquid by different algorithms.

In the heat changer (6) in an embodiment of the present invention, sources such as electricity, resistance, peltier, laser, optics, light, ultrasound, sound, dielectrophoresis, hot or cold liquids or gases can be used as a source.

In an embodiment of the invention, there are heat changers (6) inside the channel (2) preferably above the obstacles/hurdles (5) or on the inner surface of the channel (2). Heat changers (6) are located on the inner surface of the channel (2) and/or on the obstacles/hurdles (5). Heat changers (6) can perform heating or cooling. When the heat changers (6) operate, they change the heat on the surface on which they are located, in other words on the inner surface of the channel (2) and/or the obstacle/hurdle (5) surface, and performs heating or cooling on the said surface.

Heat changers (6) can be in different geometric forms and can cover all or part of the surface where they are located. Heat changers (6) are preferably powered by electricity and controlled by a control unit. Heat changers (6) can work continuously, as well as in an intermittent/pulsed way. In the preferred embodiment of the invention, heat changers (6) work in pulsed manner, at the same time, the fluid supply can be intermittent or continuous, they work for the preferred time and stop working for the preferred time.

In an embodiment of the invention, the heat changer (6) is in strip form, circular, rectangular, or elliptical form. Resistance wires are preferably used as the heat changer (6). Different heat exchanging methods can also be used as the heat changer (6). In an embodiment of the invention, all of the heat changers (6) placed in the channel (2) can be connected to each other over a single point, and it is possible to make all heat changers (6) active or passive under the same operating conditions. Heat changers (6) can be placed to cover all or part of the surfaces on which they are placed. Heat changers (6) provide the heat change of the surface where they are located. The heat changer (6) can increase or decrease the temperature of the surface on which it is located. The heat changer (6) provides the heating or cooling of the surface on which it is located. The heat changer (6) can preferably operate in a temperature range of +500 to -100 degrees. In an embodiment of the invention, the heat changer (6) increases the temperature of the surface on which it is located. The heat changer (6) is controlled by the control unit (7). The heat changer (6) is controlled by the control unit (7) and preferably operates within the specified temperature and temperature range or according to the constant operating temperature. When the heat changer (6) is activated by the control unit (7), the nanostructures mixed with the liquid coming from the fluid inlet (3) adhere to the said surfaces due to the heat change on the surfaces where the heat changer (6) is located. Due to the structure of the channel (2) where the heat changer (6) is located and the temperature change on the surface of the obstacle/hurdle (5), a vortex-like structure is formed on these surfaces due to the temperature difference. Fluids in contact with said surfaces during flow due to the said channel (2) structure and the temperature change in obstacles/hurdles (5) make micro-sized small eddy movements and remain on the surface by holding on to the channel (2) structure and the obstacles/hurdles (5) due to the vortex-like movement.

Nano-sized particles in the microfluidic in the channel (2) adhere on the surface where the heat changer (6) is located. The nanostructures that accumulate in the location of the heat changer (6) form structures like thermal vortex. Said vortex-like structures are formed by the effect of the heat change on the surfaces where the heat changer (6) is located. The flow of the fluid provided by the microfluidic entering the channel (2) space from the fluid inlet (3) changes with the heat change of the surface where the heat changer (6) is located. When the microfluidic passes over the heat changer (6) during the flow of the fluid, the flow is disrupted and the nanostructures inside adhere to the surface where the heat changer (6) is located. The nanostructures in the microfluidic can be collected at a single point on the channel (2) structure or on the obstacle/hurdle (5) by means of heat changers (6) while in the flow of the fluid. In an embodiment of the invention, the operation of the heat changers (6) is intermittent (pulsed) and the current that drives the heat changers (6) can be given as intermittent pulses. When the operation of the heat changers (6) is in the form of pulses at certain time intervals, some of the nanostructures adhere to the heat changer (6) during the flow of the microfluidic due to the temperature difference on the surface where the heat changers (6) are located.

In an embodiment of the present invention, there is a micro-channel micro-channel between the fluid inlet (3) and the fluid outlet (4). Preferably, a strip-shaped heat changer (6) is located inside the said channel. The said heat changers (6) are located in point form in an alternative application of the invention. After the inner surface (2.1) of the channel (2) is completely filled with microfluidic and nanostructure, heat changers (6) are activated by the control unit (7). With the activation of the heat changers (6), the nanostructures in the microfluidic are accumulated around the heat changers (6). When the operation of the heat changers (6) is in the form of pulses, the structure formed by the nanostructures holding around the heat changers (6) disintegrates or regathers when the heat changer is operating and stopped. As a result of the intermittent operation of the heat changers (6) always in the form of pulses, the nanostructures can be separated from the liquid nanostructures by accumulating around the heat changers (6) and distributing them back. If this process is continued, only nanostructures remain around the heat changers (6). The nanostructures are separated from the microfluid, and the remaining liquid or solution is transferred out from the fluid outlet (4). As a result of the heat changers (6) being placed in the obstacles/hurdles (5) and/or the channel (2) as a line, the nanostructures separated from the liquid also accumulate around the heat changers (6) in the form of a thin line. As a result, when all the microfluidic liquid in the channel (2) is discharged, the nanostructures accumulated around the heat changers (6) can be washed with pure water and taken outside. Thus, by means of the nanostructure purification device (1), the nanostructures are separated from the microfluidic containing nanostructures and collected on a surface, and the remaining microfluidic can be thrown out of the channel (2).

In an embodiment of the invention, the process of enriching the nanostructures in the microfluidic by separating it can be done by means of the nanostructure purification device (1). From the fluid inlet (3), the microfluidic containing nanostructure flows into the channel (2). When the microfluidic enters the channel (2), it diffuses into the channel (2) and makes a laminar flow. Meanwhile, heat changers (6) preferably located at the obstacles/hurdles (5) are operated in the channel (2). With the activation of the heat changers (6), the nanostructures begin to gather around the heat changers (6). When the heat setting of the heat changers (6) is brought to a high level, the liquid separated from the nanostructures begins to evaporate. Thus, the nanostructures collected around the heat changers (6) can be collected with less liquid.

In an embodiment of the invention, by opening and closing the heat changers (6) at certain time intervals, the nanostructures collected or accumulated around the heat changer (6) can be directed inside the channel (2). By changing the geometry and position of the obstacles/hurdles (5) and heat changers (6) placed in the space in the channel (2), the direction of the nanostructures separated from the microfluidic can be changed within the channel (2). Obstacles/hurdles (5) are placed in such a way to direct the flow of the microfluidic in the preferred direction. In an alternative embodiment of the invention, the obstacles/hurdles (5) are fixed at one end, free at one end and can move according to the impact of the microfluidic.

Along with the microfluidic, the orientation of the nanostructures can be provided by obstacles/hurdles (5) and heat changers (6). After collecting the nanostructures around the heat changer (6), the process of washing the nanostructures in the channel (2) can be performed by giving pure water from the fluid inlet. As pure water is introduced into the space in the channel (2), other liquid substances are separated from the nanostructures and the nanostructures remain in a colloidal structure. Washing of the nanostructures is carried out as pure water is supplied from the fluid inlet (3) onto the nanostructures around the heat changers (6).

In an embodiment of the invention, the control unit (7) controls and preferably provides the energy required for the operation of the heat changer (6). The control unit (7) is adapted to control the opening and closing of the heat changer (6) and operating conditions. The control unit (7) activates the heat changer (6), preferably by turning the operation energy of the heat changer (6) on and off. With the control unit (7), the heat changers (6) can be switched on and off at the same time, they can be operated in a pulsed form, and the heat change (operating) interval of the heat changers (6) can be adjusted.

In an embodiment of the invention, the operation of the nanostructure purification device (1) is carried out as follows. The nanostructure purification device (1) is preferably integrated into a microfluidic system. The microfluidic flow, preferably containing nanostructures, is connected to the nanostructure purification device (1). The microfluidic gets in and out of the nanostructure purification device (1). Nanostructures in the microfluidic are collected preferably on the channel (2) and/or the obstacle/hurdle (5) in the nanostructure purification device (1). The microfluidic is connected to the fluid Inlet (3) located on the channel (2) in the nanostructure purification device (1), allowing the microfluidic to enter the cavity in the channel (2). It flows into the microfluidic channel (2) passing through the fluid inlet (3). Since the microfluidic flows preferably from a narrow flow inlet (3) into a wide channel (2), the flow rate of the microfluidic decreases as it passes from the fluid inlet (3) to the channel (2). While the microfluidic passing through the fluid inlet (3) moves inside the channel (2), it hits the collision surfaces (5) in different geometric forms and at different locations inside the channel (2). At the same time, by operating the heat changers (6) inside the channel (2), preferably in the structure of the obstacle/hurdle (5) and/or the channel (2), the obstacle/hurdle (5) and/or channel (2) structure containing the heat changers (6) is heated or cooled. Heat changers (6) are preferably operated in the form of pulses. When the heat changers (6) operate, the nanostructures in the microfluidic flowing in the channel (2) are collected on the surface where the heat changers (6) are located. The microfluidic can be passed through the channel (2) several times, as the microfluidic passes through the channel, the nanostructures in the microfluidic increase and accumulate on the surface where the heaters are located. After the nanostructures accumulate around the heat changers (6), the separation of the non-nanostructured fluids in the microfluidic from the fluid outlet (4) is provided from the fluid outlet (4).

Since the pulse given on the heat changers (6) and the temperature difference occurs on the surfaces where the heat changer (6) is located, the nanostructures within the microfluidic are collected on hot surfaces and the solution forming the microfluidic goes out from the channel (2). Since the nanostructures are held around the heat changers (6), they cannot separate the ongoing microflow nanostructures from the surface to which they are attached. Nanostructures accumulate on the line where heat changers (6) are located. After the preferred time or after the preferred nanostructure density is achieved on surfaces whose temperature is changed, the heat changers (6) are turned off or operated in the form of pulses for a while to ensure that the microfluidic separated nanostructures are taken from where they are placed. Thus, it is possible to collect the nanostructures in the microfluidic on a surface and to remove the liquid in the microfluidic by pouring out from the channel (2).

Nanostructures around heat changers (6) can be washed with pure water transferred from the fluid inlet (3) to the cavity inside the channel (2). In this case, the pure water entering from the fluid inlet (3) spreads into the space inside the channel (2) and after washing the nanostructures on the surface, flows from the fluid outlet (4) to the external environment. At the same time, the nanostructures remaining around the heat changers (6) can be enriched with solutions with different contents transferred from the fluid inlet (3) to the space in the channel (2).

1. A microfluidics nanostructure purification device used to separate, purify, wash or enrich nanostructures by accumulating nanostructures on a surface of a microfluidics channel while the flow passing through it, , the nanostructure purification device comprising:
at least one microchannel, which connects to the microfluidic system or a flow source, an inner surface of which has a completely or partially void structure to form a cavity, nanostructures pass through the said cavity together with the fluid, at least one of the widths, length or height of the channel is maximum 1000 micrometer,
at least one fluid inlet connected to the microchannel and allowing the fluid to enter the microchannel,
at least one fluid outlet connected to the microchannel which enables the fluid to exit from the microchannel,
at least one obstacle/hurdle located between the fluid inlet and the fluid outlet in the microchannel, which changes the flow properties of the fluid in the channel by forming open chambers or notches in the channel,
at least one heat changer, which is formed by a heat exchanger and a heating/cooling source, and which is placed in the microchannel structure, inside the microchannel or in/on the obstacle/hurdle structure in the microchannel, creating a regional heat change by heating or cooling it in the microchannel and allowing the accumulation of nanostructures at the point where it is located.

2. A nanostructure purification device according to claim 1, wherein the microchannel is a hollow structure, in the form of a tetragonal prism, comprising micro channels of larger sizes than the nanostructures to be purified, in which an obstacle/hurdle and a heat changer are placed.

3. A nanostructure purification device according to claim 1, by wherein a microchannel connects the fluid inlet and the fluid outlet (4), the lower surface of which is made of glass or polymetalmethacrylate (PMMA) material or other materials that are used to produce microchannels, in which the microsized channels are observed from the bottom surface, and a heat changer is placed into said micro-sized channels therein.

4. A nanostructure purification device according to claim 1, wherein the at least one fluid inlet is connected to the microchannel, entering into the micro-sized space in the microchannel, providing an entrance to the fluid that contains nanostructures, the solution in the fluid or different solutions can be used to wash the nanostructures in the microchannel, and the at least one fluid outlet provides the exit of the fluid to the external environment from the microchannel through the micro-sized space in the microchannel.

5. A nanostructure purification device according to claim 1, wherein one or more obstacles/hurdles are in the space inside the microchannel , hitting by or contacting the flow while the flow passes through the microchannel.

6. A nanostructure purification device according to claim 1, wherein an obstacle/hurdle is placed in themicrochannel, that changes the flow in the microchannel by hitting by the fluid or by creating an obstacle/hurdle in front of the fluid passing through the microchannel, that allows nanostructure accumulation around the heat changer located thereon heat change, and that directs the flow of the fluid according to its position and location to the fluid inlet and fluid outlet (4).

7. A nanostructure purification device according to claim 1, wherein an obstacle/hurdle is placed in the microchannel vertically or horizontally to the fluid inlet and the fluid outlet (4), and which allows the flow properties (velocity, direction, shape, etc.) to be changed or divided by directly hitting by the fluid passing through the microchannel.

8. A nanostructure purification device according to claim 1, wherein an obstacle/hurdle is placed in the microchannel with an angle that starts narrowly from the fluid inlet and widens towards the fluid outlet (4), and which allows the fluid properties (velocity, direction, shape, etc.) to be changed by directly hitting by the fluid coming from the fluid inlet.

9. A nanostructure purification device according to claim 1, wherein an obstacle/hurdle is placed in the microchannel with an angle starting narrowly from the fluid inlet and widening towards the fluid outlet and positioned in such a way that there will be more than one consecutive length between them, and which allows the fluid passing through the fluid inlet to hit directly by the flow and change the flow properties (velocity, direction, shape, etc.).

10. A nanostructure purification device according to claim 1, wherein an obstacle/hurdle is placed in the channel in a vertical or horizontal position to form a tetragonal geometric form, with the comer parts facing the fluid inlet and the fluid outlet (4), and which ensures that the fluid moving in the microchannel hits and , resulting in the change of the flow properties (velocity, direction, shape, etc.).

11. A nanostructure purification device according to claim 1, wherein an obstacle/hurdle is placed into the microchannel forming a tetragonal geometric shape positioned thereof perpendicularly to each other placed as consecutive sequences from the corner sections, which ensures that the fluid moving through the microchannel hits in a phased manner in the narrowing sections placed in opposite directions that enables the fluid flow properties to change.

12. A nanostructure purification device according to claim 1, wherein an obstacle/hurdle is placed into the microchannel structure consecutively and intermittently, passing through the comers of the cavity to the center of the microchannel, and enabling the microfluidic to pass through the microchannel to expand and proceed inside the microchannel and to hit by narrowing, changing the flow (velocity, direction, shape etc.).

13. A nanostructure purification device according to claim 1, wherein a heat changer is placed in/on obstacles/hurdles or microchannel structure, which can be in different geometric forms inside the microchannel so that it does not come into contact directly with the fluid, and all of which are connected to each other over a single point and are activated or deactivated at the same time or connected to different points and are activated or deactivated individually in different operating conditions.

14. A nanostructure purification device according to claim 1, wherein a heat changer is placed in/on obstacles/hurdles or microchannel structure, which can be in different geometric forms inside the microchannel so as to contact the fluid, and all of which are connected to each other over a single point and are activated or deactivated at the same time or connected to different points and are activated or deactivated individually in different operating conditions.

15. A nanostructure purification device according to claim 1, wherein a heat changer is placed so as to fill all or part of the obstacle/hurdle or microchannel structure, and provides heat change on the surface by heating or cooling the surface it is on.

16. A nanostructure purification device according to claim 1, by wherein a heat changer is controlled by the control unit operating in the temperature range of +500 to -100 degrees, which operates in the heat and temperature range determined by the control unit, and which ensures that the nanostructures mixed with the liquid coming from the fluid inlet adhere to the said surfaces due to the heat change on the surfaces by heating/cooling the surfaces where it is located when activated by the control unit.

17. A nanostructure purification device according to claim 1, wherein a heat changer which by changing the temperature of the surface on which it is located provides a swirling motion due to the temperature difference on the said surfaces and which ensures that fluids that come into contact with said surfaces during the flow of microfluidics make micro-sized small vortex movements by holding on to the microchannel structure and obstacles/hurdles and remain on the surface by due to the said vortex-like movement.

18. A nanostructure purification device according to claim 1, wherein a heat changer enables forming of thermal vortex-like structures with the heat change on the surface of which nanostructures accumulate on, and the flow of the fluid is changed by the microfluid entering the microchannel cavity through the fluid inlet with the heat change on the surfaces that it is on.

19. A nanostructure purification device according to claim 1, wherein a heat changer ensures nanostructures to be adsorbed and released at time intervals during flow of the fluid when operated by pulses at certain time intervals.

20. A nanostructure purification device according to claim 1, wherein a heat changer uses electricity, resistance, pettier, laser, optics, light, ultrasound, sound, dielectrophoresis, hot or cold liquids or gases as heat source.
